(19) United States
(12) Patent Application Publication
(10) Pub. No.: US 2005/0139626 A1
(43) Pub. Date: Jun. 30, 2005

(54) Newsprint dispensing device

(76) Inventor: John R. Owens, Winneconne, WI (US)

Correspondence Address: Cynthia S. Murphy;Renner, Otto, Boisselle & Sklar, LLP, Nineteenth Floor, 1621 Euclid Avenue, Cleveland, OH, 44115-2191, US

(21) Appl. No.: 10/815,608

(22) Filed: Apr. 1, 2004

Related U.S. Application Data
(60) Provisional application No. 60/460,271, filed on Apr. 4, 2003.

(51) Int. Cl. B26F 3/00

(52) U.S. Cl. 225/1; 225/48; 225/56

(57) ABSTRACT

A dispensing device comprises a dispensing box, a roll of a sheet-like packaging material, and a cutting edge. The box includes a series of sides and a dispensing slot on one of these sides. The roll includes a leading portion which is inserted through the dispensing slot and pulled in a pulling direction (P). The cutting edge is positioned downstream of the dispensing slot relative to the pulling direction (P) whereby the packaging material can be dispensed in a desired length to suit the packaging needs of a particular item and then cut to this desired length by the cutting edge.

### RELATED APPLICATION

This application claims priority to U.S. Patent Application No. 60/460,271 filed on Apr. 4, 2003. The entire disclosure of this earlier application is hereby incorporated by reference.

### FIELD OF THE INVENTION

The present invention relates generally, as indicated, to a newsprint dispensing device and, more particularly, to a dispensing device which dispenses newsprint for the wrapping of soon-to-be-transported and/or stored items.

### BACKGROUND OF THE INVENTION

Certain items, such as dinnerware (e.g., cups, glasses, plates, etc.), vases, gardening pots, are commonly included in the move of a home or industry to a new location. Also, items such as this are routinely sold via catalog or Internet sales whereby they need to be shipped to the purchaser. Because these items are susceptible to fracture or damage, it is a common practice to wrap each item in newsprint. Typically, newsprint is provided in a plurality of sheets compiled in a bundle and each sheet is a set size, such as, for example, fifteen inches by thirty-two inches. To wrap an item, an entire newsprint sheet can be used regardless of the dimensions of the item. Alternatively, the newsprint sheet can be cut or torn to a smaller size, but this takes additional time and/or equipment which is usually not desirable. Furthermore, when the packing person shifts from one location to another (i.e., from the kitchen to the dining room in a residential move situation), the bundle of newsprint sheets can be bulky, clumsy, inconvenient and/or difficult to carry.

### SUMMARY OF THE INVENTION

The present invention provides a dispensing device which allows newsprint to be dispensed in desired lengths rather than set sheet dimensions. In this manner, there is not any waste and/or sheet-cutting whereby the environment is benefitted and whereby money and time are saved. Also, the dispensing device can be constructed so that it is much easier to provide and/or transport than the conventionally used newsprint sheets.

More particularly, the present invention provides a dispensing device comprising a dispensing box, a roll of a sheet-like packaging material positioned within the box, and a cutting edge. The box comprises a series of sides and a dispensing slot on one of the sides. The roll includes a leading portion which is inserted through the dispensing slot and pulled in a pulling direction. The cutting edge is positioned downstream of the dispensing slot relative to the pulling direction whereby the packaging material can be dispensed in a desired length to suit the packaging needs of a particular item and then cut to this desired length by the cutting edge.

The sheet material can be paper, more particularly newsprint, and even more particularly thirty pound newsprint. The material can be coiled around a core and core-supporting pads (e.g., plastic pads) can be inserted into each end of the core. The dimensions of the roll correspond to the dimensions of the box and the width of the roll can be slightly less (e.g., ½ inch less) than certain sides of the box. The pads preferably have mounting portions dimensioned to fit snugly within certain box sides whereby they can function as chucks when the roll is inserted into the box. A spacer can be positioned between one of the pads and the adjacent side of the box to enhance dispersal, especially with larger sized boxes.

These and other features of the invention are fully described and particularly pointed out in the claims. The following description and drawings set forth in detail certain illustrative embodiments of the invention, which are indicative of but a few of the various ways in which the principles of the invention may be employed.

### DRAWINGS

FIG. 1 is a perspective view of the dispensing device according to the present invention, the device including a dispensing box and a roll within the box for dispersal therefrom.

FIG. 2 is a schematic view of the dispensing device positioned adjacent the edge of a counter top.

FIG. 3 is a schematic view of the dispensing device positioned centrally on a table.

FIG. 4 is a schematic view of a method of carrying the dispensing device to a convenient location.

FIG. 5 is a perspective view of the dispensing box.

FIG. 6 is a plan view of a blank that can be used to construct the dispensing box of FIG. 5.

FIG. 7 is a perspective view of a longer dispensing box.

FIG. 8 is a plan view of a blank that can be used to construct the dispensing box of FIG. 7.

### DETAILED DESCRIPTION

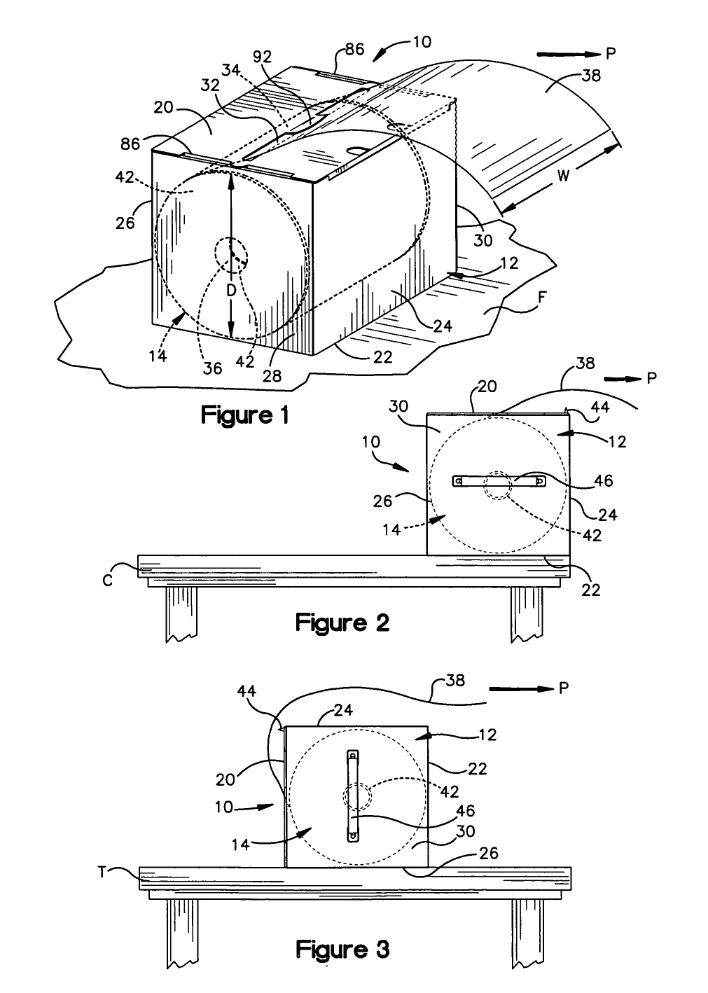

Referring now to the drawings, and initially to FIG. 1, a dispensing device 10 according to the present invention is shown. The device 10 comprises a dispensing box 12, and a roll 14 of newsprint for dispersal therefrom. As is explained in more detail below, the device 10 allows newsprint to be dispensed in desired lengths (rather than set sheet dimensions) whereby there need not being any waste. As is also explained in more detail below, the dispensing box 10 can be provided/transported much easier (and safer) than conventionally-used bundles of newsprint sheets.

The dispensing box 12 has a rectangular prism shape formed from a series of rectangular sides. The rectangular sides specifically include a first side 20 (the top side in FIG. 1), a second side 22 (the bottom side in FIG. 1), a third side 24 (the front side in FIG. 1), a fourth side 26 (the back side in FIG. 1), and fifth and sixth sides 28 and 30 (the lateral sides in FIG. 1). It may be noted for future reference that the side 20 includes a slot 32 through which newsprint is dispensed.

The roll 14 comprises a sheet material 34 coiled around a hollow core 36 whereby the material 34 has an end portion adjacent the core 36 and a leading portion 38 most remote from the core. While any sheet material suitable for packing could possibly be used, newsprint and, more particularly thirty pound newsprint is preferred. That being said, other weights of newsprint and/or other sheet-like packing materials (e.g., non-newsprint paper and non-paper materials), are possible with, and contemplated by, the present invention.

The dimensions (i.e., width W and diameter D) of the roll 14 correspond to the dimensions of the box 12. Particularly, the width W of the roll 14 corresponds to the width of the box's sides 24/26 and the diameter D of the roll 14 corresponds to the width and length of the box's sides 28/30. For loading and dispensing convenience, the width W of the roll 14 can be slightly less (i.e., ½ inch) than the width of the box sides 24/26 and the diameter D of the roll 14 can closely approximate the size of the box sides 28/30. For example, if the box 12 has 12 inch by 9 inch by 9 inch dimensions, the roll 14 could have a 11½ inch width and a 8½ inch diameter.

The roll 14 could be freely placed in the box 12. However, alternatively and as preferred, core-supporting pads 42 can be inserted into each end of the core 36. The pads 42 are preferably designed with an insertion portion which fits with the core 36 and a flanged mounting portion which extends outwardly therefrom. The flanged portions are preferably dimensioned to fit snugly within the box sides 28 and 30 whereby the pads 42 function as chucks when the roll 14 is inserted into the box 12. The pads 42 can be made of plastic, aluminum, stainless steel and/or any other suitable material, but plastic is probably preferred because of its lightweight and non-tearing qualities.

To prepare the dispensing device 10 for use, the leading portion 38 of the newsprint is inserted through the slot 32 in the side 20 of the box 12. A cutting blade (or edge) 44 is positioned adjacent the edge of the wall 20 cornering with the wall 24. The cutting edge 44 can be made of plastic, metal, or any other material which can be easily mounted (e.g., glued, clipped, etc.) to the box 12 and which provides sufficient cutting potential. Again, plastic is probably preferred because of its lightweight qualities.

During operation of the dispensing device 10, the end of the leading portion 38 may be pulled through the slot 32 and over the cutting edge 44 in a pulling direction P. When the distance between the being-pulled end and the cutting edge 44 is the desired length, the leading portion 38 can be moved downward for contact with the cutting edge 44 and separation thereof. It may be noted that the roll 14 can be positioned within the box 12 to best accommodate this motion of the newsprint 34. For example, in FIG. 1, the roll 14 is positioned so that its roll pattern is clockwise relative to the lateral side 28 of the box 12.

The dispensing device 10 can be positioned on various surfaces and in various orientations relative to the pulling direction P. For example, in FIG. 1, the dispensing device 10 is positioned on a floor F, in FIG. 2, the dispensing device 10 is positioned on the edge of a counter top C, and in FIG. 3, the dispensing device 10 is positioned in the center (i.e., away from the edges) of a table T. In FIG. 1, the box side 20 forms the top of the box 12, and the side 20 is horizontally oriented and nearest the pulling direction P. Also, the cutting blade 34 points upward. In FIG. 2, the dispensing box 10 is positioned in much the same manner with the front wall 20 also being aligned with the edge of the counter top C. In FIG. 3, the front wall 24 is vertically oriented and remote from the pulling direction P.

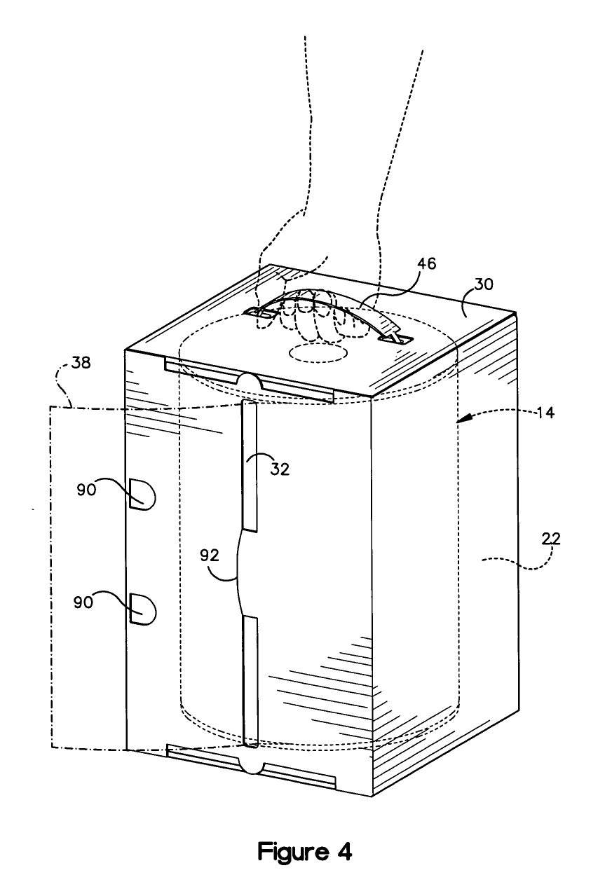

Referring additionally to FIG. 4, a handle 46 can be provided on the box 12 for convenient moving of packing materials to another room or location. In the illustrated embodiment, the handle 46 is mounted on the box side 30 whereby it is carried with this side facing up. The handle 46 can comprise a holding portion, and umbrella shaped portions extending from either end thereof. The distal end of the umbrella shaped portions can be used in conjunction with a rectangular plate and washers to mount the handle 46 onto the box 12. In any event, the handle 46 allows the dispensing device 10 to be very conveniently moved from one location to another especially when compared to, for example, the conventionally-used bundle of sheets.

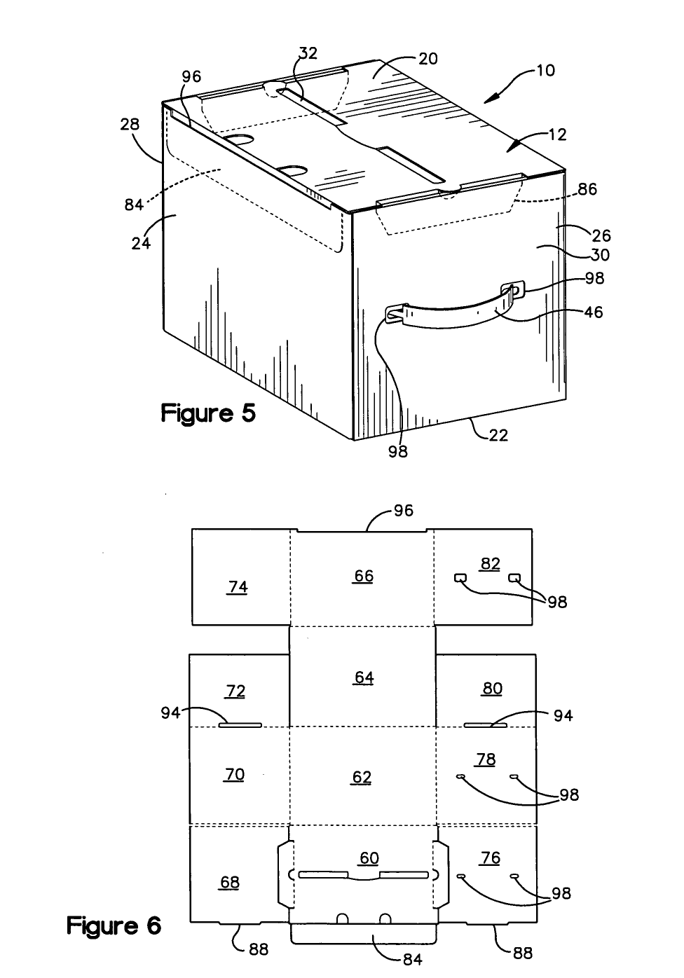

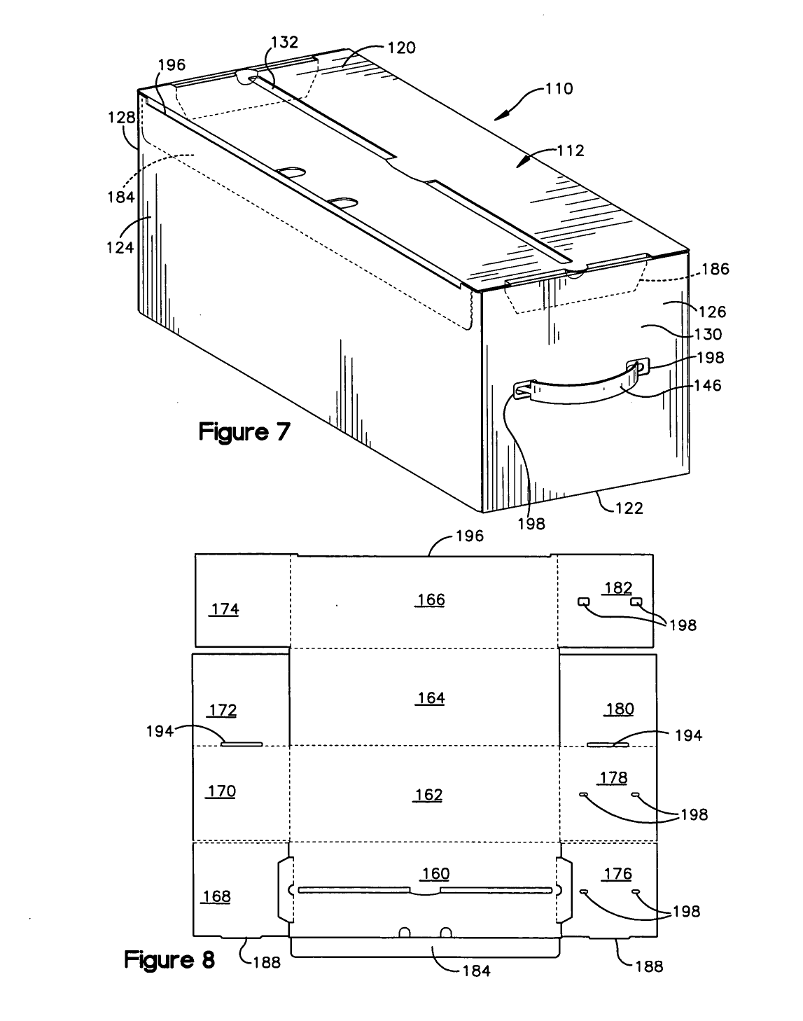

Referring now to FIG. 5, the dispensing device 10 is illustrated without the roll 14 therein whereby details of the box 12 can be seen more clearly. As is shown in FIG. 6, the box 12 can be made from a blank 58. The blank 58 comprises panels 60, 62, 64, and 66, panels 68, 70, 72 and 74, and panels 76, 78, 80 and 82. In the assembled box 12, the panel 60 forms the first side 20, the panel 62 forms the fourth side 26, the panel 64 forms the second side 22, and the panel 66 forms the third side 24. The panels 68, 70 and 74 form the fifth side 28 and the panels 76, 78, 82 form the sixth side 30. (Specifically, the panel 68/76 are the outermost layer, panels 70/78 are the innermost layers, and panels 74/82 are positioned therebetween). Panels 72 and 80 overlay the panel 64 or the second side 22 of the box 12.

Panels 60, 62, 64 and 66 are connected together by fold lines. Panels 70 and 78 are connected to panel 62, and panels 74 and 82 are connected to panel 64, by fold lines. Panels 68 and 70 are connected to each other, and panels 76 and 78 are connected to each other, by double fold lines. Panels 70 and 72 are connected to each other, and panels 78 and 80 are connected to each other, by fold lines. Panel 68 is separated by from panel 60 and panel 76 is separated from panel 60 by cut-lines. Panel 74 is separated from adjacent panel 72, and panel 82 is separated from adjacent panel 80, by a roughly rectangular gap between their neighboring edges.

The blank 58 further includes a closing tab 84, locking tabs 86, and connecting tabs 88. The closing tab 84 extends outward from the distal edge of the panel 60, and a fold line and two semi-capsule notches 90 are positioned therebetween. The locking tabs 86 extend outward from the lateral edges of the panel 60 and are formed by cuts extending into the rectangular region generally occupied by the panels 68/76. A fold line and semi-circular cut lines (each forming a semi-circular sub-tab) are positioned between the respective locking tabs 86 and the major portion of the panel 60. The connecting tabs 88 extend outward from the distal edge of the panel 68.

The dispensing slot 32 is cut into the panel 60 and this cut also provides a holding tab 92 which presses down on the leading portion 38 of the newsprint as it is dispensed from the box 12 (see FIGS. 1 and 2). The panels 72 and 80 each include a notch 94 (adjacent the neighboring fold line) which receives the connecting tabs 88. The panel 66 also includes a slot 96 along its distal edge for attachment of the cutting edge 44 and/or insertion of the closing tab 84. Panels 76, 78, and 80 each include a pair of openings 98 which, in the assembled box 12, align with each other and coordinate with the handle 46. Specifically, the umbrella portions of the handle 46 would extend through the aligned openings 98 and the rectangular plate and washers would be positioned against the inside surface of the panel 78.

Referring now to FIGS. 8 and 9, a longer version 112 of the dispensing box of the present invention, and a blank 158 for making such a box 112, are shown. The box 112 and the blank 158 have essentially the same structure as the box 12 and the blank 158 whereby like reference numerals, with a suffix “1” added, are used for corresponding components. However, it may be noted that in the box 112, two cutting blades 144 are mounted along the slot 194 and that a spacer pad (not shown) can be positioned between one of the core-pads 140 and the handle-less side 128 of the box 112. The dimensions of the roll used with the box 112 would correspond to its larger dimensions. For example, if the box 112 has 24 inch by 12 inch by 12 inch dimensions, the roll could have a 23½ inch width and a 8½ inch diameter.

One may now appreciate the present invention provides a dispensing device 10/110 that allows newsprint to be dispensed in desired lengths (rather than set sheet dimensions) and/or can be more easily (and safely) than conventionally-used bundles of newsprint sheets. Although the invention has been shown and described with respect to certain preferred embodiments, it is obvious that equivalent and obvious alterations and modifications will occur to others skilled in the art upon the reading and understanding of this specification. The present invention includes all such alterations and modifications and is limited only by the scope of the following claims.

1. A dispensing device comprising a dispensing box, a roll of a sheet-like packaging material positioned within the box, and a cutting edge;
the box comprising a series of sides and a dispensing slot on one of said sides;
the roll including a leading portion which is inserted through the dispensing slot and pulled in a pulling direction (P);
the cutting edge being positioned downstream of the dispensing slot relative to the pulling direction (P) whereby the packaging material can be dispensed in a desired length to suit the packaging needs of a particular item and then cut to this desired length by the cutting edge.

2. A dispensing device as set forth in claim 1, wherein the sides are rectangular and form a rectangular prism shape.

3. A dispensing device as set forth in claim 2, wherein the sheet material is coiled around a core and wherein the leading portion is remote from the core.

4. A dispensing device as set forth claim 1, wherein the sheet material is paper.

5. A dispensing device as set forth in claim 4, wherein the sheet material is newsprint.

6. A dispensing device as set forth in claim 5, wherein the sheet material is thirty pound newsprint.

7. A dispensing device as set forth in claim 1, wherein the dimensions of the roll correspond to the dimensions of the box.

8. A dispensing device as set forth in claim 7, wherein the width W of the roll corresponds to the length of certain sides of the box and the diameter D of the roll corresponds to the width and length of other sides of the box.

9. A dispensing device as set forth in claim 8, wherein the width W of the roll is slightly less than the length of the certain sides.

10. A dispensing device as set forth in the claim 9, wherein the width W of the roll is ½ inch less than the length of the certain sides.

11. A dispensing device as set forth in claim 1, wherein the roll includes a hollow core and wherein core-supporting pads are inserted into each end of the core.

12. A dispensing device as set forth in claim 11, wherein the pads have mounting portions preferably dimensioned to fit snugly within certain box sides whereby the pads can function as chucks when the roll is inserted into the box.

13. A dispensing device as set forth in claim 12, wherein a spacer is positioned between one of the pads and the adjacent side of the box.

14. A dispensing device as set forth in claim 13, wherein the pads are made of plastic.

15. A dispensing device as set forth in claim 14, wherein the cutting edge is positioned adjacent to an edge of the wall having the dispensing slot.

16. A dispensing device as set forth in claim 15, wherein the cutting edge is formed from two cutting blades.

17. A dispensing device as set forth in claim 16, wherein the cutting edge is made of plastic.

18. A dispensing device as set forth in claim 17, wherein a handle is provided whereby the dispensing device can be more easily provided/transported than the conventionally used bundles of newsprint sheets.

19. A dispensing device as set forth in claim 18, wherein the handle is mounted on one side of the box.

20. A dispensing device as set forth in claim 1, wherein the box has 12 inch by 9 inch by 9 inch dimensions.

21. A dispensing device as set forth in claim 1, wherein the box has 24 inch by 9 inch by 9 inch dimensions.

22. A blank for making the box set forth claim 1, the blank comprising a series of panels;
wherein the box comprises a first side, a second side, a third side, a fourth side, a fifth side, and a sixth side;
wherein a certain panel forms the first side, a certain panel forms the fourth side, a certain panel forms the second side, and a certain panel forms the third side;
wherein certain panels form the fifth side and certain panels form the sixth side; and
wherein panels overlay the second side of the box.

23. A blank as set forth in claim 22, wherein certain panels are connected together by fold lines, other certain panels are connected together by fold lines, and other panels are connected together by double fold lines; wherein certain panels are separated by cut-lines, and wherein certain panels are separated by gaps.

24. A blank as set forth in claim 23, further comprising a closing tab, locking tabs, and connecting tabs;
wherein the closing tab extends outward from the distal edge of the panel forming the first side of the box;
wherein the locking tabs extend outward from the lateral edges of the panel forming the first side of the box; and
wherein the connecting tabs extend outward from the distal end of the panel forming the fifth side of the box.

25. A blank as set forth in claim 24, wherein a fold line and two notches are positioned between the closing tab and the panel form the first side of the box.

26. A method of wrapping items comprising the steps of:
providing the dispensing device of claim 1,
pulling the leading portion of the roll in the pulling direction (P) to a desired length;
severing the leading portion against the cutting edge;
wrapping the item with the severed portion.
